(19) United States
(12) Patent Application Publication
(10) Pub. No.: US 2022/0307549 A1
(43) Pub. Date: Sep. 29, 2022

(54) MULTI-SPRING RATE WASHER

(71) Applicant: ZF Active Safety and Electronics US LLC, Livonia, MI (US)

(72) Inventors: James Loria, Macomb, MI (US); Himadri Shastry, Shelby Township, MI (US)

(21) Appl. No.: 17/211,917

(22) Filed: Mar. 25, 2021

(51) Int. Cl. F16C 25/08; F16B 43/00

(52) U.S. Cl. CPC F16C 25/083; F16B 43/00; F16C 2380/26

(57) ABSTRACT

A washer includes a first portion with a first spring rate and a second portion with a second spring rate different from the first spring rate edge.

### FIELD OF THE INVENTION

The present invention is directed to a washer and, more particularly, to a washer having multiple spring rates.

### BACKGROUND OF THE INVENTION

Various washers are known. For example, one particular type of washer is a wave washer. A wave washer has an annular body formed around an axis into a wave shape. Wave washers are designed to have a single spring rate and thus, are inadequate for certain applications.

### SUMMARY OF THE INVENTION

According to one aspect, a washer can include a first portion with a first spring rate. The washer can further include a second portion with a second spring rate. The second spring rate can be different from the first spring rate.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a schematic perspective side view of a washer constructed in accordance with the present disclosure;

FIG. 2 is schematic side view of a portion of the washer of FIG. 1;

FIG. 3 is a schematic side view of an example use application for the washer of FIG. 1; and

FIG. 4 is a graph mapping characteristics of the washer of FIG. 1.

### DETAILED DESCRIPTION OF THE INVENTION

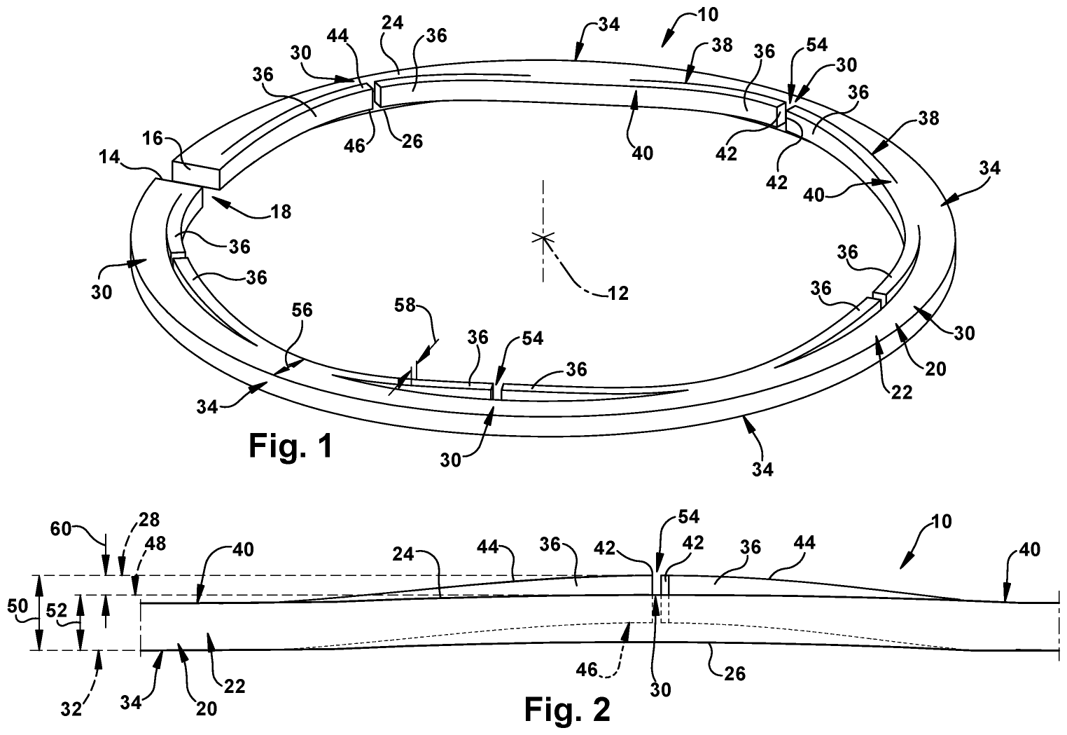

A washer 10 constructed in accordance with the present invention is shown in FIG. 1. The washer 10 may be ring-shaped and extend circumferentially about an axis 12 of the washer. The washer 10 may have oppositely facing first and second ends 14, 16 that are circumferentially spaced from each other and define a radially extending split 18 in the washer.

A base portion 20 of the washer 10 has waves 22 extending in the circumferential direction about the axis 12. The base portion 20 also has oppositely facing first and second axial end surfaces 24, 26. As shown in FIG. 2, the first axial end surface 24 intersects a first plane 28 at a crest 30 of each wave 22. The second axial end surface 26 intersects a second plane 32 at a trough 34 of each wave 22. The first and second planes 28, 32 are parallel to one another and perpendicular to the axis 12.

As shown in FIGS. 1-2, at least one prong 36 is radially inward of the base portion 20 and radially between the axis 12 and the base portion. The prong 36 may be formed as one piece with the base portion 20 and radially split from the base portion by a circumferentially extending slit 38. The prong 36 may thus be connected to and integrally joined with the base portion 20 only at a first end 40 of the prong. The prong 36 extends in the circumferential direction from the base portion 20 to a second end 42 of the prong. The second end 42 may be radially adjacent to a crest 30, as is shown in FIGS. 1-2, or circumferentially spaced from each of the crests.

The prong 36 also extends in the axial direction from the base portion 20. A first axial end surface 44 of the prong 36 is axially spaced from the first axial end surface 24 of the base portion 20. A second axial end surface 46 of the prong 36, which is opposite the first axial end surface 44, may also be spaced from the second axial end surface 26 of the base portion 20. The first axial end surface 44 intersects a third plane 48 at the second end 42 while the second axial end surface 46 intersects the second plane 32 at the first end 40. The third plane 48 is parallel to the first and second planes 28, 32 and perpendicular to the axis 12. A distance 50 between the second and third planes 32, 48 (i.e., an axial height 50 of the prong 36) is greater than a distance 52 between the first and second planes 28, 32 (i.e., an axial height 52 of the base portion 20).

As shown in FIGS. 1-2, the washer 10 includes a plurality of prongs 36. Each of the prongs 36 may circumferentially extend toward an associated other prong. The second ends 42 of two associated prongs 36 thus are opposite to and face one another. The second ends 42 of two associated prongs may define a radial split 54 between the second ends. The splits 54, along with the circumferentially extending slits 38, allows the prongs 36 to flex relative to each other and relative to the base portion 20.

Alternatively, the second ends 42 of two associated prongs 36 may be integrally joined to one another so that there is no split 54 between the second ends. In such a configuration, the joined prongs 36 collectively form a single wave-shaped extension that extends from the base portion 20. The joined prongs 36 are flexible relative to the base portion 20 because of the separation provided by an associated circumferentially extending slit 38.

The prongs 36 have a first spring rate and the base portion 20 has a second spring rate that is different from the first spring rate. In the example configuration of the washer 10 of FIGS. 1-2, the first spring rate is less than the second spring rate. At least one of a radial width 56 of the washer 10, a ratio of a radial width 58 of the prongs 36 to the radial width of the washer, the axial height 50 of the prongs, and an axial distance 60 between the first and third planes 28, 48 is selected to produce a desired value for the first spring rate. Therefore, the first spring rate can be altered by adjusting one or more of the radial width 56 of the washer 10, the ratio of the radial width 58 of the prongs 36 to the radial width of the washer, the axial height 50 of the prongs, and the distance 60 between the first and third planes 28, 48. Similarly, at least one of the radial width 56 of the washer 10, the ratio of the radial width 58 of the prongs 36 to the radial width of the washer, the axial height 52 of the base portion 20, and the distance 60 between the first and third planes 28, 48 is selected to produce a desired value for the second spring rate. Therefore, the second spring rate can be altered by adjusting one or more of the radial width 56 of the washer 10, the ratio of the radial width 58 of the prongs 36 to the radial width of the washer, the axial height 52 of the base portion 10, and the distance 60 between the first and third planes 28, 48.

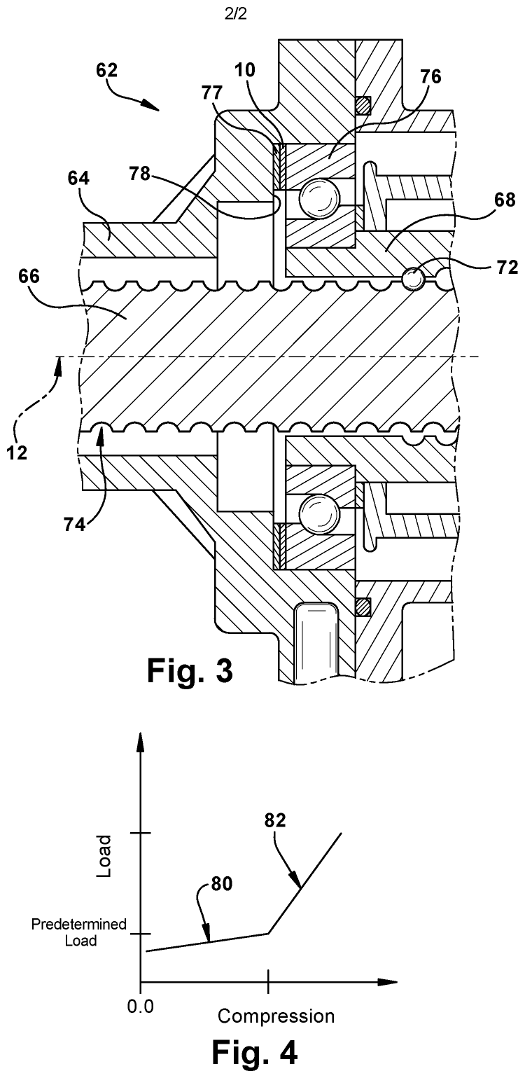

The washer 10 may be used in the place of conventional, single-spring rate washers and/or in any application that would benefit from the use of a single washer that has multiple spring rates. FIG. 3 illustrates one example application for the washer 10.

A portion of a power steering assembly 62 for use in a vehicle is shown in FIG. 3. The power steering assembly 62 includes a housing 64 and a steering member 66 in the housing. A ball nut 68 is operatively connected to a threaded portion 70 of the steering member 66 with balls 72 of the ball nut being between threads 74 of the threaded portion. A bearing 76 rotatably supports the ball nut 68 for rotation relative to the housing 64 and the steering member 66. Rotation of the ball nut 68 causes the steering member 66 to axially move relative to the housing 64 to turn steerable vehicle wheels.

The washer 10 is axially between the bearing 76 and an inner surface 78 of the housing 64. As is shown in FIG. 3, the power steering assembly 62 is constructed with the washer 10 engaging both the bearing 76 and a spacer 77 that is axially between the washer and the inner surface 78. The spacer 77 may be a generally rigid or non-flexible member, such as, for example, a flat washer. Alternatively, The power steering assembly 62 can be constructed with the washer 10 engaging both the bearing 76 and the inner surface 78.

The washer 10 supports the ball nut 68, through the bearing 76, so that the ball nut may axially sway relative to the threaded portion 70 in order to alleviate or prevent misalignment between the ball nut and the threaded portion. The swaying ball nut 68 axially loads the washer 10 with a minor load (i.e., a load that is below a predetermined load), which flexes/compresses the prongs 36 in the axial direction. Therefore, by being compressible under minor loads, the prongs 36 permit the ball nut 68 to sway in order to alleviate or prevent misalignment.

The second spring rate, however, may be selected so that the base portion 20 does not compress under minor loads. The prongs 36 may thus flex under minor loads relative to the base portion 20. Wear on the base portion 20 and the washer 10 as a whole may be reduced by having only the prongs 36 flex under minor loads.

During dynamic events, such as road disturbances and small on-center maneuvers of the vehicle, a load on the washer 10 from the ball nut 68 may reach at least the predetermined load. The first and second spring rates are selected so that the prongs 36 and the base portion 20 axially flex/compress under the predetermined load. Prior to the load on the washer 10 reaching the predetermined load, the prongs 36 are axially compressed ahead of the base portion 20 at the first spring rate. FIG. 4 maps this relationship in that a first line segment 80 represents the compression of the prongs 36 at the first spring rate.

Prior to receiving the predetermined load, the axial height 50 of the prongs 36 is greater than the axial height 52 of the base portion 20. This difference in the heights 50, 52 may be one cause for the prongs 36 being compressed ahead of the base portion 20 since the load on the washer 10 may reach the prongs before the base portion. The first spring rate being lower than the second spring rate, and thus causing only the prongs 36 to compress under minor loads, may be another cause for the prongs being compressed ahead of the base portion 20. The axial height 50 of the prongs 36, however, is reduced as the prongs are loaded and compressed. The split 54 between associated prongs 36 may also be reduced as the prongs are compressed. The second end 42 of at least one of the prongs 36 may engage the second end of an associated prong as the prongs are compressed and/or when the load on the washer 10 at least equals the predetermined load.

Once the load on the washer 10 reaches the predetermined load, the axial height 50 of the prongs 36 is compressed to a value that equals the axial height 52 of the base portion 20 and both the prongs and base portion are loaded. Loads at least equaling the predetermined load thus compress the prongs 36 and the base portion 20 as a single unit. The collective compression of the prongs 36 and base portion 20 may be at a combined spring rate. FIG. 4 maps this relationship in that a second line segment 82 represents the collective compression of the prongs 36 and the base portion 20 at the combined spring rate. The combined spring rate may be greater than or equal to the second spring rate.

A potential advantage of the designed compressibility of the washer 10 is that the washer may effectively “decouple” the ball nut 68 from the housing 64 to reduce system noise, vibration and harshness (NVH) from being transmitted to the housing and thus into the vehicle during dynamic events.

From the above description of the invention, those skilled in the art will perceive improvements, changes and modifications. Such improvements, changes and modifications within the skill of the art are intended to be covered by the appended claims.

Having described the invention, the following is claimed:

1. A washer, comprising:
a first portion with a first spring rate; and
a second portion with a second spring rate different from the first spring rate.

2. The washer recited in claim 1, wherein oppositely facing first and second ends of the washer are spaced from each other and define a split radially extending therethrough.

3. The washer recited in claim 1, wherein
the first portion has waves extending in a circumferential direction about an axis,
the second portion being radially inward of the first portion and including at least one prong, the prong having a first end connected to the first portion, the prong extending from the base portion to a second end of the prong.

4. The washer recited in claim 3, wherein each wave intersects a first plane at a crest and intersects a second plane at a trough, the first and second planes being parallel to one another and perpendicular to the axis, the second end of the at least one prong being radially adjacent to the crest of one of the waves.

5. The washer recited in claim 3, wherein each wave intersects a first plane at a crest and intersecting a second plane at a trough, the first and second planes being parallel to one another and perpendicular to the axis, the second end of the at least one prong being circumferentially spaced from the crests.

6. The washer recited in claim 3, wherein each wave intersects a first plane at a crest and intersects a second plane at a trough, the first end of the at least one prong intersecting the second plane, the second end of the at least one prong intersecting a third plane, the first, second and third planes being parallel to one another and perpendicular to the axis, an axial distance between the first and second planes being less than an axial distance between the second and third planes.

7. The washer recited in claim 3, wherein a first axial end surface of the at least one prong is axially spaced from a first axial end surface of the first portion, the first axial end surfaces of the at least one prong and first portion facing in the same axial direction.

8. The washer recited in claim 7, wherein the at least one prong includes a second axial end surface opposite the first axial end surface of the at least one prong, the first portion including a second axial end surface opposite the first axial end surface of the first portion, the second axial end surfaces of the at least one prong and the first portion being axially spaced from one another.

9. The washer recited in claim 7, wherein the waves of the first portion include crests, the first axial end surface of the first portion at the crests being axially spaced from the first axial end surface of the at least one prong at the second end of the at least one prong.

10. The washer recited in claim 3, wherein an axial height of the prong is greater than an axial height of the first portion.

11. The washer recited in claim 3, wherein the at least one prong is radially separated from the base portion by a circumferentially extending slit.

12. The washer recited in claim 3, wherein the at least one prong is flexible relative to the base portion.

13. The washer recited in claim 3, wherein the second portion includes a plurality of prongs, each of the prongs circumferentially extending toward an associated other prong, the second ends of two associated prongs oppositely facing one another and defining a radial slit between the second ends.

14. The washer recited in claim 1, wherein the second portion includes a plurality of prongs, each of the prongs circumferentially extending toward an associated other prong, the second ends of two associated prongs being integrally joined to one another.

15. The washer recited in claim 1, wherein the second portion is radially inward of the first portion and includes at least one prong, the prong having a first end connected to the first portion, the prong extending from the base portion in both a circumferential direction and an axial direction.

16. The washer recited in claim 15, wherein the first portion includes at least one wave extending about an axis of the washer, an axial height of the at least one wave being less than an axial height of the at least one prong.

17. The washer recited in claim 1, wherein the first and second portions are formed as one piece.

18. A power steering assembly for use in a vehicle, the power steering assembly including the washer recited in claim 1.

19. The power steering assembly of claim 18, further comprising:
a steering member in a housing and including a threaded portion;
a ball nut operatively connected to the threaded portion of the steering member for effecting axial movement of the steering member upon rotation of the ball nut; and
a bearing rotatably supporting the ball nut for rotation relative to the housing and the steering member;
the washer being between the bearing and an inner surface of the housing.
